(19) United States
(12) Patent Application Publication
(10) Pub. No.: US 2019/0280287 A1
(43) Pub. Date: Sep. 12, 2019

(54) SECONDARY BATTERY AND METHOD FOR MANUFACTURING THE SAME

(71) Applicant: SANYO Electric Co., Ltd., Daito-shi, Osaka (JP)

(72) Inventors: Masao Fukunaga, Hyogo (JP); Tetsuya Sato, Hyogo (JP)

(73) Assignee: SANYO Electric Co., Ltd., Daito-shi, Osaka (JP)

(21) Appl. No.: 16/319,555

(22) PCT Filed: Jul. 24, 2017
(86) PCT No.: PCT/JP2017/026627

§ 371 Date: Jan. 22, 2019

(30) Foreign Application Priority Data
Jul. 28, 2016 (JP) 2016-148097

(51) Int. Cl. H01M 4/139; H01M 2/34; H01M 2/26; H01M 4/04; H01M 10/0585; H01M 4/58

(52) U.S. Cl. CPC H01M 4/139; H01M 2/345; H01M 2/26; H01M 4/0404; H01M 2004/028; H01M 10/0585; H01M 4/5825; H01M 2200/20; H01M 4/043

(57) ABSTRACT

A positive electrode plate including a positive electrode core and a positive electrode active material mixture layer formed on the positive electrode core is produced. The positive electrode plate includes a positive electrode exposed core portion at an end thereof. The positive electrode plate has a flat region in which the thickness of the positive electrode active material mixture layer is substantially uniform and an inclined portion in which the thickness of the positive electrode active material mixture layer gradually decreases from an end of the flat region toward the positive electrode exposed core portion. The positive electrode plate is cut such that a boundary between a main portion of the positive electrode plate and a positive electrode tab portion (40) is at the inclined portion. After that, the positive electrode active material mixture layer is compressed.

### TECHNICAL FIELD

The present invention relates to a secondary battery and a method for manufacturing the secondary battery.

### BACKGROUND ART

Secondary batteries, such as nonaqueous electrolyte secondary batteries, are included in driving power sources of, for example, electric vehicles (EVs) and hybrid electric vehicles (HEVs or PHEVs).

A secondary battery includes positive and negative electrode plates which each include a core made of metallic foil and active material mixture layers formed on the surfaces of the core and containing an active material. Secondary batteries for electric vehicles (EVs) and hybrid electric vehicles (HEVs or PHEVs) desirably have higher volume energy densities. The volume energy density of a secondary battery may be increased by increasing the packing density of the active material mixture layers. In such a case, the amounts of active materials contained in a battery case may be increased, and the volume energy density increases accordingly. The packing density of the active material mixture layers may be increased by, for example, increasing force applied in a compression process in which the active material mixture layers that have been formed on the core are compressed with a roll press or the like. Thus, the packing density of the active material mixture layers may be increased.

However, when the force applied to the active material mixture layers on the core in the compression process is increased, not only the active material mixture layers but also the core on the surfaces of which the active material mixture layers are formed is strongly compressed. Thus, the core is also subjected to rolling. When the core includes an exposed core portion on which the active material mixture layers are not formed at an end of the electrode plate, the exposed core portion does not receive load in the compression process because the thickness thereof is less than that of a portion on which the active material mixture layers are formed. Therefore, when the electrode plate is subjected to the compression process, the portion of the core on which the active material mixture layers are formed is subjected to rolling, but the exposed core portion is not subjected to rolling. As a result, the portion of the core on which the active material mixture layers are formed and the exposed core portions have different lengths. The difference in length causes problems such as wrinkles on the core and bending of the electrode plate.

To solve these problems, PTL 1 given below proposes a technology of elongating the exposed core portion of the electrode plate in advance and then roll-pressing the electrode plate.

### CITATION LIST

### Patent Literature

PTL 1: Japanese Published Unexamined Patent Application No. 2014-220113

### SUMMARY OF INVENTION

### Technical Problem

An object of the invention of the present application is to provide a secondary battery with increased reliability.

### Solution to Problem

According to an aspect of the present invention, a method for manufacturing a secondary battery including an electrode assembly including a first electrode plate and a second electrode plate, the first electrode plate including a core and an active material mixture layer formed on the core, the first electrode plate having a main portion and a tab portion formed of a portion of the core that projects from an end of the main portion, includes:

an active-material-mixture-layer-forming step of forming the active material mixture layer on the core such that the core includes an exposed core portion on which the active material mixture layer is not formed;

a tab-portion-forming step of forming the tab portion by cutting the exposed core portion after the active-material-mixture-layer-forming step; and

a compression step of compressing the active material mixture layer after the tab-portion-forming step.

In the active-material-mixture-layer-forming step, the active material mixture layer is formed on the core such that the active material mixture layer includes an inclined portion in which a thickness of the active material mixture layer gradually decreases toward the exposed core portion in a region near an end of the active material mixture layer that is adjacent to the exposed core portion.

In the tab-portion-forming step, the core is cut such that a boundary between the main portion and the tab portion is at the inclined portion.

According to the above-described method, the first electrode plate can be prevented from being ruptured or cut in a region around the boundary between the main portion and the tab portion in the compression step of compressing the active material mixture layer. Preferably, the first electrode plate is a positive electrode plate, and the second electrode plate is a negative electrode plate.

An electrode plate that includes a core and active material mixture layers formed on both sides of the core and that has an exposed core portion serving as a tab portion at an end thereof may be manufactured by the following procedure.

(1) Forming the active material mixture layers on both sides of the core having an elongated shape such that the exposed core portion is formed to extend in the longitudinal direction of the core on each side of the core at an end in the width direction of the core.

(2) Forming a tab portion by cutting the exposed core portion into a predetermined shape.

(3) Performing a compression process (pressing process) on the electrode plate having an elongated shape on which the tab portion is formed to compress the active material mixture layers.

The inventors have found that when the electrode plate is manufactured by the above-described procedure, cracks that extend at an angle may be formed at the base of the tab portion if the pressure applied to the electrode plate in the compression process is increased to increase the packing density of the active material mixture layers. Such a problem probably occurs due to the following reasons.

It has generally been considered that when the electrode plate is subjected to the compression process after the tab portion is formed by cutting the exposed core portion into a predetermined shape, the electrode plate is not easy wrinkled, bent, or cracked, for example even if the compression process causes a difference in length between the portion of the core on which the active material mixture layers are formed and the exposed core portion. More specifically, it has been considered that since the exposed core portion is cut in regions having certain gaps therebetween, even if the compression process causes a difference in length between the portion of the core on which the active material mixture layers are formed and the exposed core portion, the strain is released at the positions at which the exposed core portion is cut so that the electrode plate is not easy wrinkled, bent, or cracked, for example.

However, the inventors have found that cracks may be formed at the base of the tab portion even when the electrode plate is subjected to the pressing process after the tab portion is formed by cutting the exposed core portion into a predetermined shape. The inventors have also found that this problem is significant when the packing density of the active material mixture layers after the compression process is greater than or equal to 3.50 g/cm³ and when the width of the tab portion is greater than or equal to 8 mm, more particularly when the width of the tab portion is greater than or equal to 10 mm. Although the occurrence of cracks at the base of the tab portion can be somewhat reduced by reducing the width of the tab portion to below 10 mm, this is not preferable because the electric resistance increases when the width of the tab portion is excessively small.

According to the above-described method, the thickness of the active material mixture layer gradually decreases at the boundary between the main portion and the tab portion of the electrode plate. Therefore, when the active material mixture layer is subjected to the compression process, the degree of expansion of the core gradually changes from the main portion to the tab portion of the electrode plate. Accordingly, a portion in which the degree of expansion of the core suddenly changes is not easily formed. As a result, the occurrence of rupture or cut at the boundary between the main portion and the tab portion of the first electrode plate can be prevented in the compression step of compressing the active material mixture layer.

Preferably, in the active-material-mixture-layer-forming step, the active material mixture layer is formed to extend in a longitudinal direction of the core having an elongated shape on each side of the core such that the exposed core portion is formed on each side of the core at an end in a width direction of the core.

Preferably, in the tab-portion-forming step, a plurality of the tab portions are formed with gaps therebetween in the longitudinal direction of the core, and the core and the active material mixture layer are cut in the longitudinal direction of the core at the inclined portion in regions between the tab portions that are adjacent to each other.

Preferably, in the tab-portion-forming step, a plurality of the tab portions are formed with gaps therebetween in the longitudinal direction of the core, and a distance in the longitudinal direction of the core between the tab portions that are adjacent to each other in the longitudinal direction of the core is greater than or equal to three times a width of the tab portions in the longitudinal direction of the core.

Preferably, in the tab-portion-forming step, the core is cut by irradiation with an energy ray.

Preferably, the secondary battery further includes a battery case that contains the electrode assembly, a first electrode external terminal that is attached to the battery case and electrically connected to the first electrode plate, and a current interruption mechanism or a short circuiting mechanism, the current interruption mechanism being activated when a pressure in the battery case reaches or exceeds a predetermined value and breaking a conductive path between the first electrode plate and the first electrode external terminal, the short circuiting mechanism being activated when the pressure in the battery case reaches or exceeds a predetermined value and electrically short-circuiting the first electrode plate and the second electrode plate. Preferably, the first electrode plate is a positive electrode plate, and the active material mixture layer contains lithium carbonate.

Preferably, the electrode assembly includes a separator disposed between the first electrode plate and the second electrode plate, and the method further includes a step of bonding the first electrode plate and the separator together.

A secondary battery according to an aspect of the present invention includes an electrode assembly including a first electrode plate and a second electrode plate, the first electrode plate including a core and an active material mixture layer formed on the core, the first electrode plate having a main portion and a tab portion formed of a portion of the core that projects from an end of the main portion. A packing density of a portion of the active material mixture layer located at a boundary between the main portion and the tab portion is less than a packing density of the active material mixture layer in a central region of the main portion.

The secondary battery having the above-described structure is highly reliable, and the first electrode plate is not easily ruptured or cut in a region around the boundary between the tab portion and the main portion.

Preferably, a region in which the active material mixture layer has a packing density less than the packing density of the active material mixture layer in the central region of the main portion is formed along an edge of the main portion on which the tab portion is provided at the end of the main portion.

Preferably, the secondary battery further includes a battery case that contains the electrode assembly; a first electrode external terminal that is attached to the battery case and electrically connected to the first electrode plate; and a current interruption mechanism or a short circuiting mechanism, the current interruption mechanism being activated when a pressure in the battery case reaches or exceeds a predetermined value and breaking a conductive path between the first electrode plate and the first electrode external terminal, the short circuiting mechanism being activated when the pressure in the battery case reaches or exceeds a predetermined value and short-circuiting the first electrode plate and the second electrode plate. Preferably, the first electrode plate is a positive electrode plate, and the active material mixture layer contains lithium carbonate.

Preferably, the electrode assembly includes a separator disposed between the first electrode plate and the second electrode plate, and the first electrode plate and the separator are bonded together.

The active material mixture layer may be melted and solidified along an edge of the main portion on which the tab portion is provided.

Preferably, a length of an edge of the main portion on which the tab portion is provided is greater than or equal to three times a width of the tab portion in a direction in which the edge extends.

### Advantageous Effects of Invention

The present invention provides a secondary battery with increased reliability.

### BRIEF DESCRIPTION OF DRAWINGS

FIG. 1 is a perspective view of a rectangular secondary battery according to an embodiment.

FIG. 2 is a sectional view of FIG. 1 taken along line II-II.

FIG. 3 is a plan view of a positive electrode plate according to the embodiment before tab portions are formed.

FIG. 4 is a sectional view of FIG. 3 taken along line IV-IV.

FIG. 5 is a plan view of the positive electrode plate according to the embodiment after the tab portions are formed.

FIG. 6 VI(a) is a sectional view of FIG. 5 taken along line VI(a)-VI(a), and V(b) is a sectional view of FIG. 5 taken along line VI(b)-VI(b).

FIG. 7 illustrates a compression step of compressing the positive electrode plate.

FIG. 8 is a plan view of the positive electrode plate according to the embodiment after a cutting process.

FIG. 9 IX(a) is a sectional view of FIG. 8 taken along line IX(a)-IX(a), and IX(b) is a sectional view of FIG. 8 taken along line IX(b)-IX(b).

FIG. 10 is a plan view of a negative electrode plate according to the embodiment after a cutting process.

FIG. 11 is a plan view of an electrode assembly according to the embodiment.

FIG. 12 is an enlarged view of a portion including a current interruption mechanism illustrated in FIG. 2.

FIG. 13 is a sectional view of a positive electrode plate according to a modification taken in a direction in which a tab portion projects.

FIG. 14 illustrates a positive electrode plate according to Reference Example 1.

FIG. 15 illustrates a positive electrode plate according to Reference Example 2.

FIG. 16 illustrates a positive electrode plate according to Reference Example 3.

FIG. 17 is a sectional view of a short circuiting mechanism.

FIG. 18 illustrates a fuse portion provided on a current collector.

### DESCRIPTION OF EMBODIMENTS

A rectangular nonaqueous electrolyte secondary battery according to an embodiment of the present invention will now be described. The present invention is not limited to the embodiment described below.

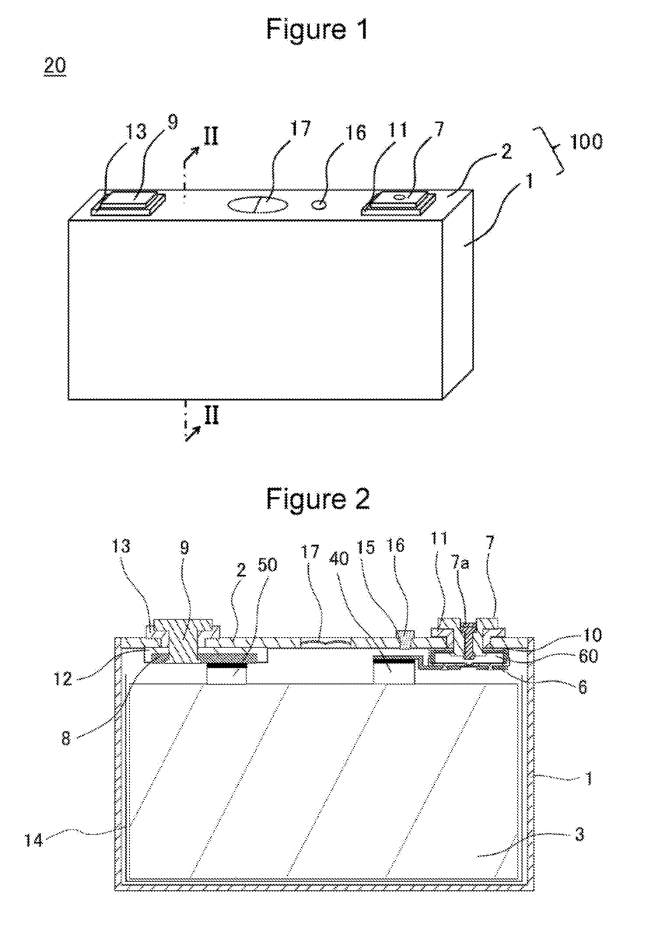

The structure of a rectangular secondary battery 20 will be described with reference to FIGS. 1 and 2. A battery case 100 includes an exterior body 1 having the shape of a rectangular tube with a bottom and an open top, and a sealing plate 2 that seals the opening in the exterior body 1. The battery case 100 contains an electrode assembly 3, which includes positive electrode plates, negative electrode plates, and separators, together with electrolytic solution. The exterior body 1 and the sealing plate 2 are preferably made of a metal, preferably aluminum or an aluminum alloy. An insulating sheet 14 is disposed between the electrode assembly 3 and the exterior body 1.

Each positive electrode plate includes a positive electrode tab portion 40, and each negative electrode plate includes a negative electrode tab portion 50. The positive electrode tab portion 40 and the negative electrode tab portion 50 are disposed adjacent to the sealing plate 2 in the electrode assembly 3. A positive electrode external terminal 7, which is electrically connected to the positive electrode plates, and a negative electrode external terminal 9, which is electrically connected to the negative electrode plates, are attached to the sealing plate 2. A positive electrode current collector 6 is connected to the positive electrode plates. A current interruption mechanism 60 is provided between the positive electrode external terminal 7 and the positive electrode plates. The current interruption mechanism 60 is activated to break the conductive path between the positive electrode external terminal 7 and the positive electrode plates when a pressure in the battery case 100 reaches or exceeds a predetermined value. A negative electrode current collector 8 is connected to the negative electrode plates.

An outer insulating member 11 is disposed between the sealing plate 2 and the positive electrode external terminal 7. An inner insulating member 12 is disposed between the sealing plate 2 and the negative electrode current collector 8. An outer insulating member 13 is disposed between the sealing plate 2 and the negative electrode external terminal 9.

The sealing plate 2 has an electrolytic solution introduction hole 15. The electrolytic solution introduction hole 15 is sealed by a sealing plug 16 after the electrolytic solution is introduced into the battery case 100 through the electrolytic solution introduction hole 15. The sealing plate 2 is provided with a gas discharge valve 17 that breaks and enables gas in the battery case 100 to be discharged out of the battery case 100 when the pressure in the battery case 100 reaches or exceeds a predetermined value. The activating pressure of the gas discharge valve 17 is set to a pressure higher than the activating pressure of the current interruption mechanism 60.

A method for manufacturing a positive electrode plate will now be described.

### [Production of Slurry for Positive Electrode Active Material Mixture Layer]

A slurry for a positive electrode active material mixture layer is produced by mixing a lithium nickel cobalt manganese composite oxide that serves as a positive electrode active material, polyvinylidene fluoride (PVdF) that serves as a binder, a carbon material that serves as a conductive agent, lithium carbonate, and N-methyl-2-pyrrolidone (NMP) that serves as a dispersion medium. The mass ratio between the lithium nickel cobalt manganese composite oxide, PVdF, the carbon material, and lithium carbonate is 94:2:3:1.

### [Positive-Electrode-Active-Material-Mixture-Layer-Forming Step]

The slurry for the positive electrode active material mixture layer produced by the above-described method is applied to both sides of an aluminum foil that serves as a positive electrode core and has a thickness of 15 μm. At this time, the slurry for the positive electrode active material mixture layer is applied to the positive electrode core in a central region thereof in the width direction. Then, the positive electrode core to which the slurry for the positive electrode active material mixture layer is applied is dried to remove NMP in the slurry. Thus, the positive electrode active material mixture layer is formed.

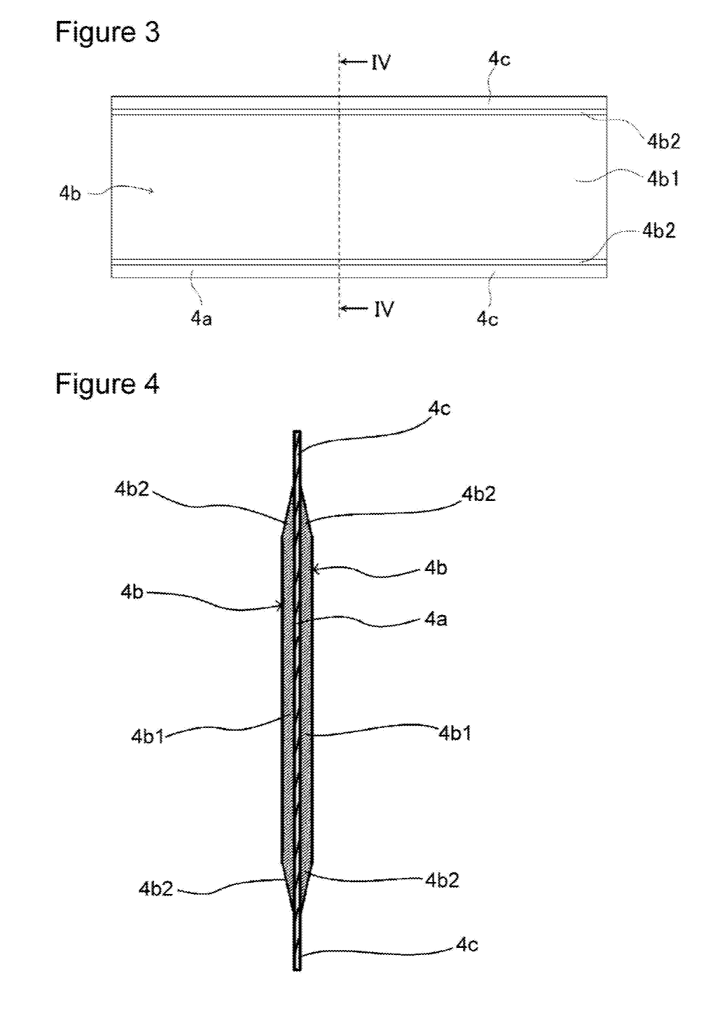

FIG. 3 is a plan view of a positive electrode plate 4 produced by the above-described method before tab portions are formed. FIG. 4 is a sectional view of FIG. 3 taken along line IV-IV. Positive electrode active material mixture layers 4b are formed on both sides of a positive electrode core 4a and extend in the longitudinal direction of the positive electrode core 4a. The positive electrode core 4a includes positive electrode exposed core portions 4c at both ends of the region in which the positive electrode active material mixture layers 4b are formed in the width direction. Each positive electrode active material mixture layer 4b includes a flat region 4b1 in which the thickness thereof is substantially uniform and inclined portions 4b2 in which the thickness thereof gradually decreases from the sides adjacent to the flat region 4b1 toward the positive electrode exposed core portions 4c. Each positive electrode active material mixture layer 4b has small projections and recesses on the surface thereof. Therefore, it is not necessary that the positive electrode active material mixture layer 4b have a completely uniform thickness in the flat region 4b1 as long as the thickness thereof is substantially uniform. The inclined portions 4b2 are provided at both ends of the flat region 4b1 and extend in the longitudinal direction of the positive electrode plate 4. The width of the inclined portions 4b2 (length in the vertical direction in FIG. 3, or length in the direction in which the positive electrode tab portions 40 project) is preferably 1 mm to 10 mm, and more preferably 2 mm to 8 mm. The ratio of the width of the inclined portions 4b2 to the width of the flat region 4b1 (length in the vertical direction in FIG. 3, or length in the direction in which the positive electrode tab portions 40 project) is preferably 1 to 10%, and more preferably 1 to 8%.

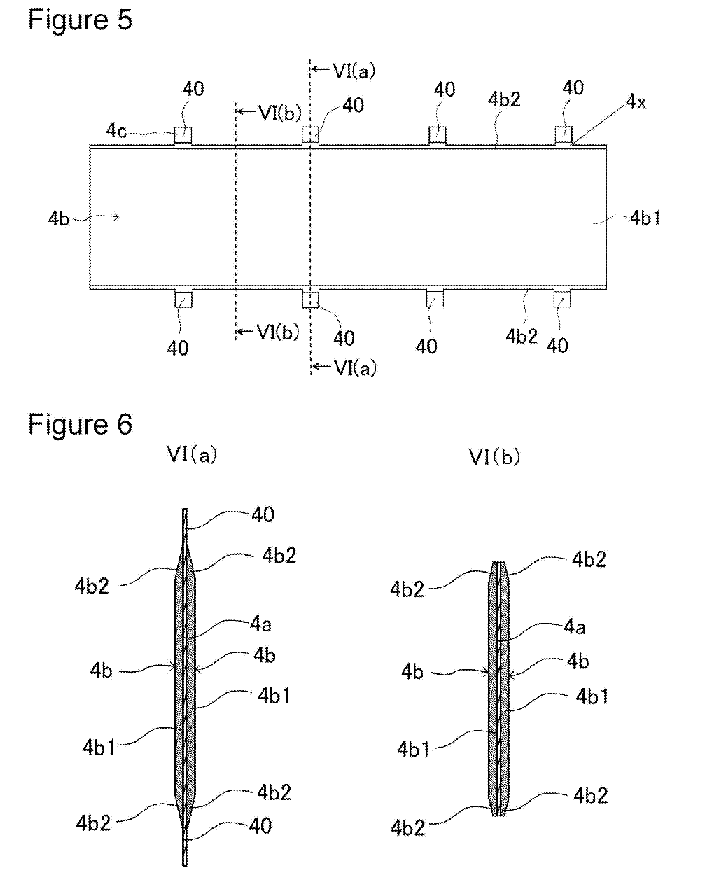

The positive electrode plate 4 before the formation of the tab portions illustrated in FIG. 3 is cut into the shape illustrated in FIG. 5. As illustrated in FIG. 5, the positive electrode tab portions 40 are composed of the positive electrode exposed core portions 4c. The positive electrode tab portions 40 are formed at both ends of the positive electrode plate 4 in the width direction. The positive electrode tab portions 40 are arranged with gaps therebetween in the longitudinal direction of the positive electrode plate 4. In regions between two positive electrode tab portions 40, the positive electrode plate 4 is cut in the longitudinal direction of the positive electrode plate 4 at the inclined portions 4b2. Portions of the positive electrode active material mixture layers 4b that are cut by irradiation with an energy ray, such as a laser beam, are temporarily melted and then solidified.

The positive electrode tab portions 40 are preferably formed by cutting the positive electrode plate 4 by irradiation with an energy ray, such as a laser beam. In particular, when the inclined portions 4b2 are cut, the positive electrode plate 4 is preferably cut by irradiation with an energy ray. As illustrated in FIG. 5, boundaries 4X between a main portion of the positive electrode plate and the positive electrode tab portions 40 are at the inclined portions 4b2.

FIG. 6 shows sectional views of the positive electrode plate 4 after the positive electrode tab portions 40 are formed. In FIG. 6, VI(a) is a sectional view of FIG. 5 taken along line VI(a)-VI(a). In addition, in FIG. 6, VI(b) is a sectional view of FIG. 5 taken along line VI(b)-VI(b).

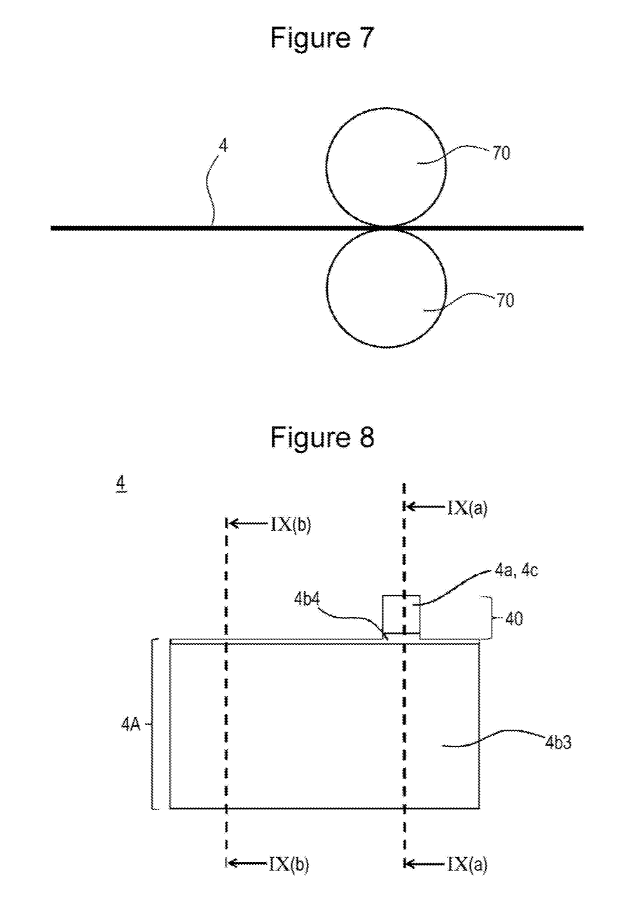

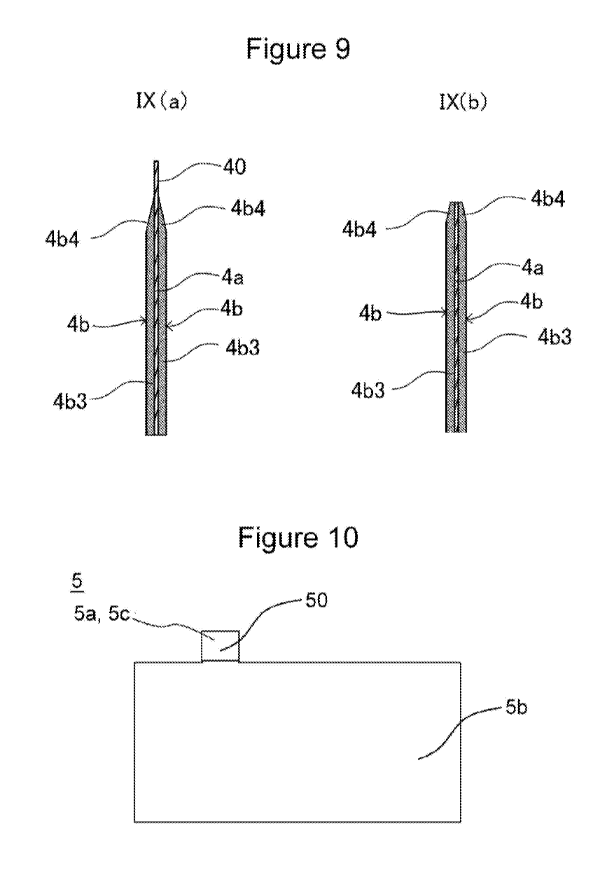

Next, the positive electrode plate 4 on which the positive electrode tab portions 40 are formed is subjected to a compression process. As illustrated in FIG. 7, the positive electrode plate 4 is compressed by a pair of compression rollers 70. Accordingly, the positive electrode active material mixture layers 4b of the positive electrode plate 4 are compressed so that the packing density is set to a predetermined value. The positive electrode active material mixture layers 4b preferably have a packing density greater than or equal to 3.50 g/cm³ after the compression process.

Before the positive electrode active material mixture layers 4b of the positive electrode plate 4 produced by the above-described method are subjected to the compression step, the boundaries 4X between the main portion 4A and the positive electrode tab portions 40 of the positive electrode plate 4 are at the inclined portions 4b2 in which the thickness of the positive electrode active material mixture layers 4b gradually decreases. Therefore, in the compression step of compressing the positive electrode active material mixture layers 4b, the degree of expansion of the positive electrode core 4a gradually changes from the main portion 4A to the positive electrode tab portions 40 of the positive electrode plate 4. Accordingly, a portion in which the degree of expansion of the positive electrode core 4a suddenly changes is not easily formed. As a result, the occurrence of rupture or cut at regions around the boundaries between the main portion 4A and the positive electrode tab portions 40 can be prevented in the compression step of compressing the positive electrode active material mixture layers 4b.

The positive electrode plate 4 that has been subjected to the compression process is cut in the longitudinal direction of the positive electrode plate 4 at the center thereof in the width direction of the positive electrode plate 4. The positive electrode plate 4 is further cut in the width direction of the positive electrode plate 4 at predetermined pitches in the longitudinal direction of the positive electrode plate 4. Thus, the positive electrode plate 4 having a predetermined shape illustrated in FIG. 8 is obtained.

The positive electrode plate 4 illustrated in FIG. 8 includes the main portion 4A and the positive electrode tab portion 40 that projects from an edge of the main portion 4A. The main portion 4A of the positive electrode plate 4 illustrated in FIG. 8 has a rectangular shape. It is not necessary that the main portion be rectangular, but the main portion 4A preferably has a substantially rectangular shape. The corners of the main portion 4A may be chamfered or rounded, or be cut. The main portion 4A of the positive electrode plate 4 may have curved edges.

As illustrated in FIG. 8, the main portion 4A of the positive electrode plate 4 includes a first region 4b3 and a second region 4b4 in which the packing density of each positive electrode active material mixture layer 4b is less than the packing density of each positive electrode active material mixture layer 4b in the first region 4b3. A portion of the second region 4b4 is also provided on the positive electrode tab portion 40.

### [Production of Negative Electrode Plate]

A slurry for a negative electrode active material mixture layer containing graphite as a negative electrode active material, styrene-butadiene rubber (SBR) as a binder, carboxymethyl cellulose (CMC) as a thickener, and water is prepared. The slurry for the negative electrode active material mixture layer is applied to both sides of a rectangular copper foil that serves as a negative electrode core and has a thickness of 8 μm. Then, the slurry for the negative electrode active material mixture layer is dried to remove water contained therein so that negative electrode active material mixture layers 5b are formed on the negative electrode core. After that, a compression process is performed so that the thickness of the negative electrode active material mixture layers 5b is reduced to a predetermined thickness. The thus-obtained negative electrode plate is cut into a predetermined shape to produce a negative electrode plate 5 illustrated in FIG. 10. The negative electrode plate 5 includes the negative electrode active material mixture layers 5b formed on both sides of the negative electrode core and a negative electrode tab portion 50 composed of a negative electrode exposed core portion 5c, which is a portion of a negative electrode core 5a that is exposed at one end of the negative electrode plate 5.

### [Production of Electrode Assembly]

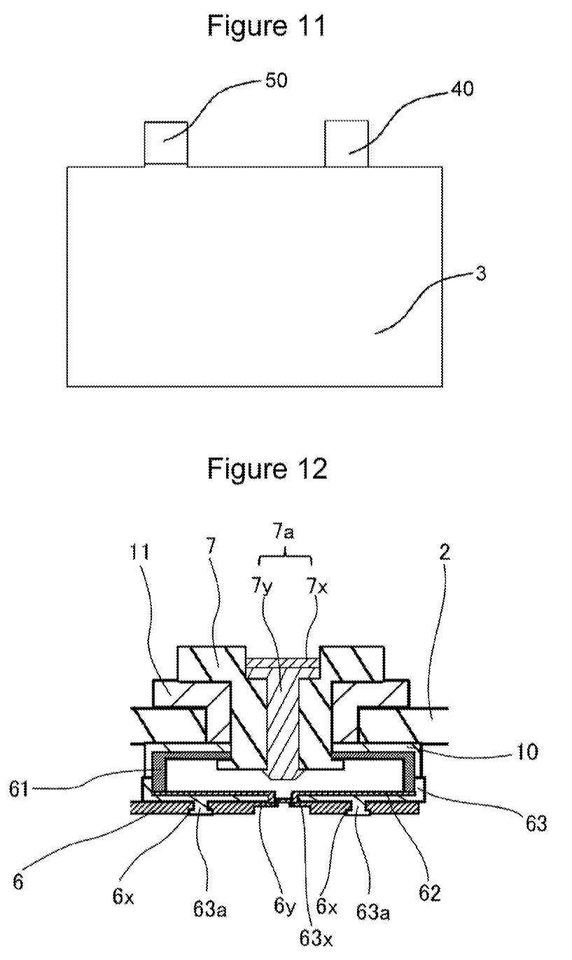

A plurality of positive electrode plates 4 and a plurality of negative electrode plates 5 produced by the above-described method are alternately stacked with separators made of polyolefin interposed therebetween to produce the electrode assembly 3 having a stacked structure. Each of the positive electrode plates 4 and each of the negative electrode plates 5 are flat, and are not curved. As illustrated in FIG. 11, the positive electrode tab portions 40 in a stacked state and the negative electrode tab portions 50 in a stacked state project from one end of the electrode assembly 3. The shape of the separators included in the electrode assembly 3 is not particularly limited. A plurality of flat separators may be used. Alternatively, a plurality of bag-shaped separators that contain positive or negative electrode plates may be used. Alternatively, a separator having a fan-folded shape may be used. The positive electrode plates 4 are preferably bonded to the separators. The negative electrode plates 5 are also preferably bonded to the separators. The outer periphery of the electrode assembly 3 may be covered by a resin sheet, such as a separator. The outer periphery of the electrode assembly 3 may be fixed with, for example, a piece of tape.

### [Assembly of Sealing Body]

As illustrated in FIGS. 2 and 12, the outer insulating member 11 is disposed in a region surrounding a through hole in the sealing plate 2 and facing the outside of the battery, and the inner insulating member 10 and a cup-shaped conductive member 61 are disposed in a region surrounding the through hole in the sealing plate 2 and facing the inside of the battery. The positive electrode external terminal 7 is inserted into through holes formed in the outer insulating member 11, the sealing plate 2, the inner insulating member 10, and the conductive member 61 from the outside of the battery, and an end of the positive electrode external terminal 7 is crimped onto the conductive member 61. The crimped portion of the positive electrode external terminal 7 is laser welded to the conductive member 61.

After that, the opening in the conductive member 61 that faces the electrode assembly 3 is covered with a deformation plate 62, and the peripheral edge of the deformation plate 62 is laser welded to the conductive member 61. Then, an insulating member 63 having an insulating member opening 63x at the center thereof is placed below the deformation plate 62. The insulating member 63 is preferably connected to the inner insulating member 10. Preferably, the insulating member 63 is latched to the inner insulating member 10.

Next, the positive electrode current collector 6 is placed below the insulating member 63. The insulating member 63 includes projecting portions 63a that project downward. The positive electrode current collector 6 has fixing openings 6x at positions corresponding to the projecting portions 63a. The insulating member 63 is connected to the positive electrode current collector 6 by inserting the projecting portions 63a into the fixing openings 6x in the positive electrode current collector 6 and heat crimping the ends of the projecting portions 63a. Alternatively, the insulating member 63 that has been connected to the positive electrode current collector 6 in advance may be connected to the inner insulating member 10. The deformation plate 62 and the positive electrode current collector 6 are welded together in the insulating member opening 63x in the insulating member 63.

When the pressure in the battery case 100 reaches or exceeds a predetermined value, the deformation plate 62 is deformed such that the central portion of the deformation plate 62 approaches the positive electrode external terminal 7. Then, a thin portion 6y of the positive electrode current collector 6 breaks to disconnect the conductive path between the positive electrode external terminal 7 and the positive electrode plates 4. The positive electrode external terminal 7 has a through hole for a leak test, for example, and the through hole is sealed by a terminal sealing member 7a. The terminal sealing member 7a preferably includes a metal plate 7x and a rubber member 7y.

The outer insulating member 13 is disposed in a region surrounding a through hole in the sealing plate 2 and facing the outside of the battery, and the inner insulating member 12 and the negative electrode current collector 8 are disposed in a region surrounding the through hole in the sealing plate 2 and facing the inside of the battery. The negative electrode external terminal 9 is inserted into through holes formed in the outer insulating member 13, the sealing plate 2, the inner insulating member 12, and the negative electrode current collector 8 from the outside of the battery, and an end of the negative electrode external terminal 9 is crimped onto the negative electrode current collector 8. The crimped portion of the negative electrode external terminal 9 is preferably laser welded to the negative electrode current collector 8.

### [Connection Between Tab Portions and Current Collectors]

The positive electrode tab portions 40 in a stacked state are placed on a portion of the positive electrode current collector 6 that is substantially parallel to (for example, at an angle in the range of ±10° relative to) the sealing plate 2, and are welded to the positive electrode current collector 6. Also, the negative electrode tab portions 50 in a stacked state are placed on a portion of the negative electrode current collector 8 that is substantially parallel to the sealing plate 2, and are welded to the negative electrode current collector 8. After that, the positive electrode tab portions 40 and the negative electrode tab portions 50 are bent so that the electrode assembly 3 is placed below the sealing plate 2. The welding method may be, for example, resistance welding, laser welding, or ultrasonic welding.

### [Assembly of Secondary Battery]

The electrode assembly 3 covered by the insulating sheet 14 is inserted into the exterior body 1 having the shape of a rectangular tube with a bottom. Then, the exterior body 1 and the sealing plate 2 are welded together to seal the opening in the exterior body 1. After that, nonaqueous electrolytic solution containing electrolyte and solvent is introduced through the electrolytic solution introduction hole 15 in the sealing plate 2. After that, the electrolytic solution introduction hole 15 is sealed with the sealing plug 16.

### [Regarding Rectangular Secondary Battery 20]

Each of the positive electrode plates 4 produced by the above-described method is not easily ruptured or cut in a region around the boundary between the main portion 4A and the positive electrode tab portion 40. Therefore, the secondary battery has increased reliability.

In each positive electrode plate 4, the packing density of the positive electrode active material mixture layers 4b at the boundary between the main portion 4A and the positive electrode tab portion 40 is less than the packing density of the positive electrode active material mixture layers 4b in a central region of the main portion 4A of the positive electrode plate 4. The central region of the main portion 4A of the positive electrode plate 4 is a central region of the main portion 4A in plan view of the positive electrode plate 4. In other words, the central region of the main portion 4A of the positive electrode plate 4 is a central region of the main portion 4A in both a direction in which the positive electrode tab portion 40 of the positive electrode plate 4 projects and a direction perpendicular to the direction in which the positive electrode tab portion 40 of the positive electrode plate 4 projects. Accordingly, the electrolytic solution can be easily introduced into the positive electrode active material mixture layers 4b. In addition, when the positive electrode active material mixture layers 4b contain lithium carbonate and when the rectangular secondary battery 20 includes the current interruption mechanism 60, the carbonic acid gas generated in the positive electrode active material mixture layers 4b is smoothly discharged out of the electrode assembly 3. Therefore, when an abnormality occurs in the rectangular secondary battery 20, the current interruption mechanism 60 can be quickly activated. Such an effect is particularly significant when the positive electrode plates and the separators are bonded together.

In the step of forming the positive electrode tab portions 40, the positive electrode tab portions 40 are arranged in the longitudinal direction of the positive electrode core 4a with gaps therebetween. In addition, the positive electrode core 4a and the positive electrode active material mixture layers 4b are cut in the longitudinal direction of the positive electrode core 4a at the inclined portions 4b2 in regions between the positive electrode tab portions 40 that are adjacent to each other. When the positive electrode plate 4 produced in this manner is subjected to the compression process, the regions in which the packing density is less than the packing density of the positive electrode active material mixture layers 4b in the central region of the main portion 4A are formed along the edges of the main portion 4A of the positive electrode plate 4 at the ends at which the positive electrode tab portions 40 are formed. With this structure, introduction of the electrolytic solution into the positive electrode active material mixture layers 4b of the positive electrode plate 4 is facilitated. Accordingly, introduction of the electrolytic solution into the electrode assembly 3 is also facilitated. In addition, when the positive electrode active material mixture layers 4b contain lithium carbonate and when the rectangular secondary battery 20 includes the current interruption mechanism 60, the carbonic acid gas generated in the positive electrode active material mixture layers 4b is smoothly discharged out of the electrode assembly 3. Therefore, when an abnormality occurs in the rectangular secondary battery 20, the current interruption mechanism 60 can be quickly activated. Such an effect is particularly significant when the positive electrode plates and the separators are bonded together.

When the positive electrode plates and the separators are bonded together, ceramic-particle-containing layers containing ceramic particles and a binder are preferably disposed between the positive electrode plates and the separators. The ceramic particles are preferably alumina particles, titania particles, silica particles, or the like. The binder is preferably a resin binder. The ceramic particles differ from the positive electrode active material. The separators are preferably porous membranes made of a resin, such as polyolefin. The above-described ceramic-particle-containing layers are preferably disposed between the positive electrode plates and the separators. The positive electrode plates and the separators may be bonded together by the ceramic-particle-containing layers. Alternatively, adhesive layers other than the ceramic-particle-containing layers may be provided, and the positive electrode plates and the separators may be bonded together by the adhesive layers. In such a case, the positional relationship may be such that a positive electrode plate, an adhesive layer, a ceramic-particle-containing layer, and a separator are arranged in that order. The voidage of the ceramic-particle-containing layers is preferably greater than the voidage of the central region of the positive electrode active material mixture layers. In such a case, gas generated in the positive electrode active material mixture layers can be smoothly discharged to the outside of the electrode assembly.

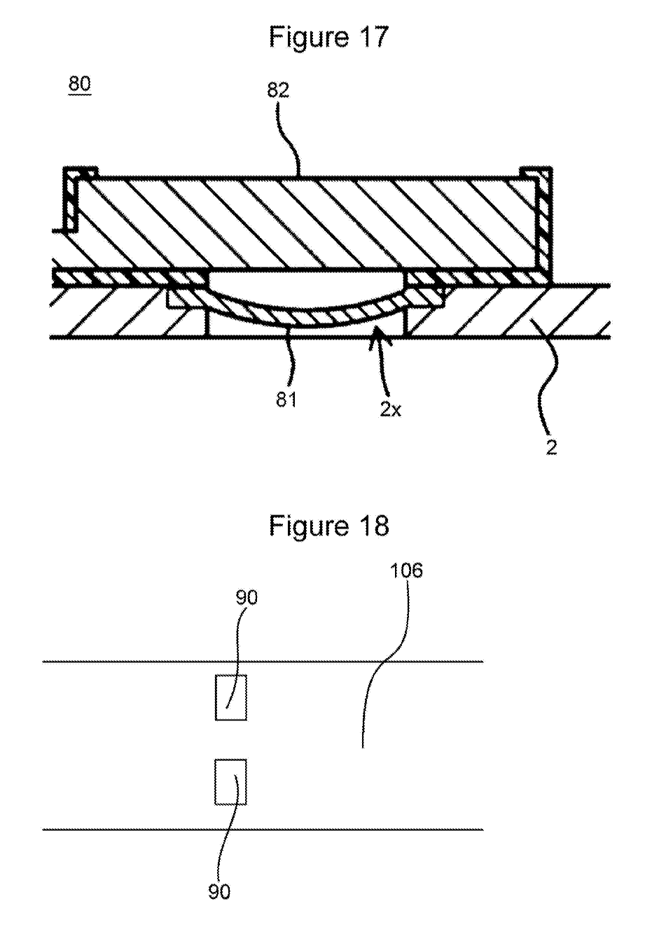

The secondary battery may include a short circuiting mechanism 80, which is activated when the pressure in the battery case 100 reaches or exceeds a predetermined value, instead of the current interruption mechanism 60. FIG. 17 is a sectional view of the short circuiting mechanism 80. The short circuiting mechanism 80 includes a deformation plate 81 that is provided on the sealing plate 2 and that is deformed when the pressure in the battery case reaches or exceeds the predetermined value and an external conductive member 82 disposed above the deformation plate 81. The deformation plate 81 is arranged to cover a through hole 2x formed in the sealing plate 2. The deformation plate 81 is electrically connected to the positive electrode plates 4 by the sealing plate 2 and the positive electrode current collector 6. The external conductive member 82 is electrically connected to the negative electrode plates 5 by the negative electrode external terminal 9. When the deformation plate 81 is deformed and comes into electrical contact with the external conductive member 82, the positive electrode plates 4 and the negative electrode plates 5 are electrically connected to each other. Accordingly, the energy in the electrode assembly 3 is discharged.

Preferably, a conductive path for the positive electrode current collector, for example, is provided with a fuse portion that blows out in response to a short-circuit current. FIG. 18 is a top view of a positive electrode current collector provided with fuse portions. A positive electrode current collector 106 has openings 90 that serve as fuse portions. Referring to FIG. 18, the positive electrode external terminal is connected at one end in the left-right direction, and the positive electrode plates are connected at the other end.

As illustrated in FIG. 5, when the positive electrode tab portions 40 are arranged with gaps therebetween in the longitudinal direction of the positive electrode core 4a (left-right direction in FIG. 5), the distance between the adjacent positive electrode tab portions 40 in the longitudinal direction of the positive electrode core 4a is preferably greater than or equal to three times the width of the positive electrode tab portions 40 in the longitudinal direction of the positive electrode core 4a, and more preferably greater than or equal to five times the width of the positive electrode tab portions 40 in the longitudinal direction of the positive electrode core 4a. With this structure, the occurrence of wrinkles and cracks in the electrode plates can be more effectively prevented. The width of the positive electrode tab portions 40 in the longitudinal direction of the positive electrode core 4a is preferably greater than or equal to 10 mm, and more preferably greater than or equal to 15 mm.

In addition, the length of the edge of the main portion 4A of each positive electrode plate 4 on which the positive electrode tab portion 40 is provided is preferably greater than or equal to three times the width of the positive electrode tab portion 40, and more preferably greater than or equal to five times the width of the positive electrode tab portion 40.

In the positive electrode plate 4 before the formation of the positive electrode tab portions 40 illustrated in FIG. 3, the width of the inclined portions 4b2 (length in the vertical direction in FIG. 3, or length in the direction in which the positive electrode tab portions 40 project) may be less than or equal to 2 mm. For example, the width of the inclined portions 4b2 may be 0.5 mm to 1.8 mm. In this case, as described above, the positive electrode tab portions 40 are preferably formed such that the distance between the adjacent positive electrode tab portions 40 in the longitudinal direction of the positive electrode core 4a is greater than or equal to three times the width of the positive electrode tab portions 40 in the longitudinal direction of the positive electrode core 4a, more preferably greater than or equal to five times the width of the positive electrode tab portions 40 in the longitudinal direction of the positive electrode core 4a. Thus, a highly reliable secondary battery with increased volume energy density can be obtained.

### [First Modification]

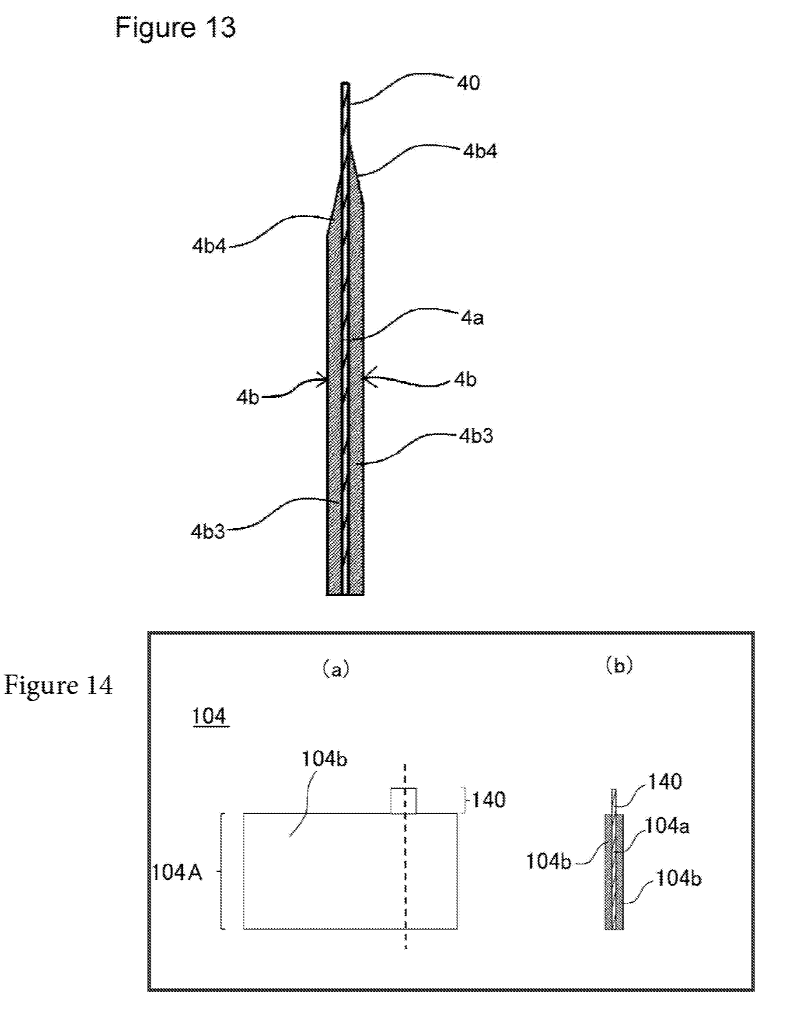

FIG. 13 is a sectional view of a positive electrode plate 4 according to a first modification before positive electrode active material mixture layers 4b are subjected to a compression process. The sectional view of the positive electrode plate 4 illustrated in FIG. 13 is taken in a direction in which a positive electrode tab portion 40 projects, and illustrates a portion including the positive electrode tab portion 40. In the positive electrode plate 4 according to the first modification before the positive electrode active material mixture layers 4b are subjected to the compression process, an end portion of the positive electrode active material mixture layer 4b formed on one side of a positive electrode core 4a and an end portion of the positive electrode active material mixture layer 4b formed on the other side of the positive electrode core 4a are at different positions in the direction in which the positive electrode tab portion 40 projects. The above-described positive electrode plate 4 can be more effectively prevented from being ruptured or cut.

### Reference Example 1

FIG. 14 illustrates a positive electrode plate 104 according to a reference example. The positive electrode plate 104 is in a state before compression of positive electrode active material mixture layers 104b. In FIG. 14, (a) is a plan view of the positive electrode plate 104, and (b) is a sectional view of (a) taken along the broken line. The positive electrode plate 104 includes a positive electrode core 104a and the positive electrode active material mixture layers 104b formed on both sides of the positive electrode core 104a. The positive electrode plate 104 also includes a positive electrode tab portion 140, and the boundary between a main portion 104A and the positive electrode tab portion 140 of the positive electrode plate 104 is at the same position as ends of the positive electrode active material mixture layers 104b. With this structure, when the positive electrode active material mixture layers 104b are subjected to a compression process, the positive electrode plate 104 is easily ruptured or cut in a region around the base of the positive electrode tab portion 140.

### Reference Example 2

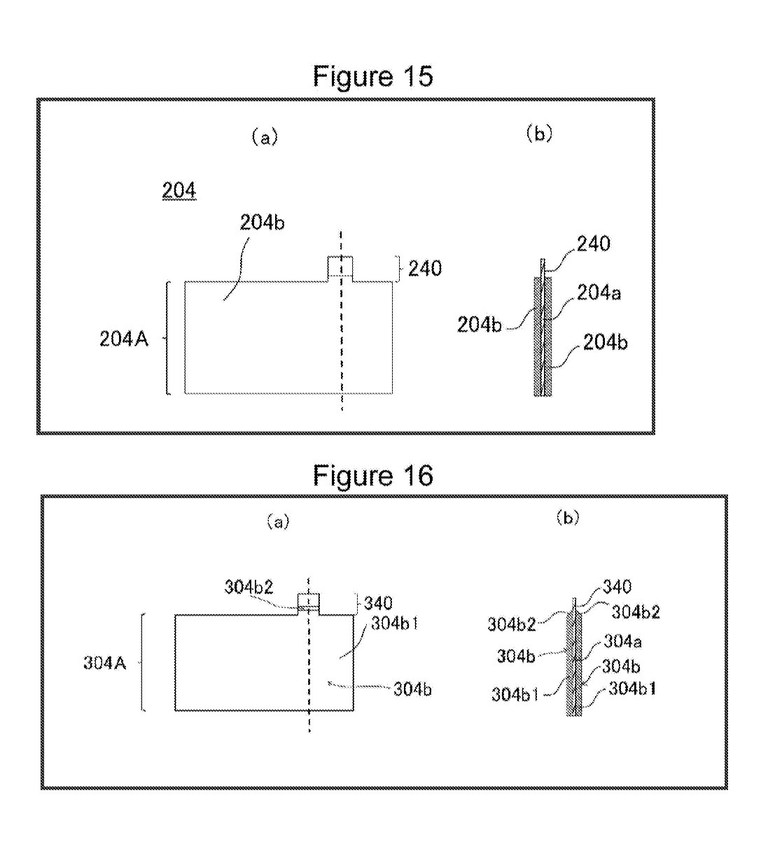

FIG. 15 illustrates a positive electrode plate 204 according to another reference example. The positive electrode plate 204 is in a state before compression of positive electrode active material mixture layers 204b. In FIG. 15, (a) is a plan view of the positive electrode plate 204, and (b) is a sectional view of (a) taken along the broken line. The positive electrode plate 204 includes a positive electrode core 204a and the positive electrode active material mixture layers 204b formed on both sides of the positive electrode core 204a. The positive electrode plate 204 is configured such that ends of the positive electrode active material mixture layers 204b are on a positive electrode tab portion 240 and that no inclined portions are provided in the regions around the ends of the positive electrode active material mixture layers 204b. In this case, although the positive electrode plate 204 is not easily ruptured or cut at the boundary between a main portion 204A and the positive electrode tab portion 240, there is a risk that the positive electrode plate 204 will be ruptured or cut at the boundary between a positive electrode exposed core portion and the ends of the positive electrode active material mixture layers 204b. In addition, the volumes of the positive electrode active material mixture layers 204b formed on the positive electrode tab portion 240 are increased, and therefore the volumes of the positive electrode active material mixture layers 204b formed on one and the other sides of the positive electrode core 204a tend to differ from each other. When the difference between the volumes of the positive electrode active material mixture layers 204b formed on one and the other sides of the positive electrode core 204a is large, there is a risk that the positive electrode tab portion 240 will be significantly tilted toward one side when the positive electrode active material mixture layers 204b are subjected to the compression process.

### Reference Example 3

FIG. 16 illustrates a positive electrode plate 304 according to another reference example. The positive electrode plate 304 is in a state before compression of positive electrode active material mixture layers 304b. In FIG. 16, (a) is a plan view of the positive electrode plate 304, and (b) is a sectional view of (a) taken along the broken line. The positive electrode plate 304 includes a positive electrode core 304a and the positive electrode active material mixture layers 304b formed on both sides of the positive electrode core 304a. The positive electrode plate 304 includes a flat region 304b1 in which the thickness of each positive electrode active material mixture layer 304b is substantially uniform and an inclined portion 304b2 in which the thickness of each positive electrode active material mixture layer 304b gradually decreases toward a portion of the positive electrode core 304a that is exposed. The boundary between a main portion 304A and a positive electrode tab portion 340 is disposed in the flat region 304b1. In this case, the positive electrode active material mixture layers 304b are formed over large regions on the positive electrode tab portion 340. Therefore, there is a problem that the positive electrode active material mixture layers 304b easily come into contact with the negative electrode plates. In addition, the positive electrode tab portion 340 cannot be easily bent. In addition, the volumes of the positive electrode active material mixture layers 304b formed on the positive electrode tab portion 340 are increased, and therefore the volumes of the positive electrode active material mixture layers 304b formed on one and the other sides of the positive electrode core 304a tend to differ from each other. When the difference between the volumes of the positive electrode active material mixture layers 304b formed on one and the other sides of the positive electrode core 304a is large, there is a risk that the positive electrode tab portion 340 will be significantly tilted toward one side when the positive electrode active material mixture layers 304b are subjected to the compression process.

### <Others>

The present invention may be applied to both positive and negative electrode plates. In particular, the invention of the present application is effectively applicable to positive electrode plates. More particularly, the invention of the present application is effectively applicable to positive electrode plates including positive electrode active material mixture layers having a packing density greater than or equal to 3.50 g/cm³ after the compression process.

According to the present invention, the core is preferably composed of nonporous metallic foil. When the core is a positive electrode core, the core is preferably composed of aluminum foil or aluminum alloy foil. When the core is a negative electrode core, the core is preferably composed of copper foil or copper metal foil.

The shape of the electrode assembly according to the present invention is not particularly limited. The electrode assembly may either have a wound structure or a stacked structure. Preferably, the electrode assembly has a stacked structure including a plurality of flat positive electrode plates and a plurality of flat negative electrode plates. The shape of the separators disposed between the positive electrode plates and the negative electrode plates are also not particularly limited. Flat separators may be disposed between the positive electrode plates and the negative electrode plates. The separators may instead be bag-shaped and have positive electrode plates disposed therein. Alternatively, a separator may be fan-folded such that the positive electrode plates and the negative electrode plates are disposed between the folded portions of the separator.

The positive electrode active material according to the present invention is preferably a lithium transition metal composite oxide. In particular, the positive electrode active material is preferably a lithium transition metal composite oxide containing at least one of nickel, cobalt, and manganese.

The negative electrode active material according to the present invention may be a material capable of occluding and releasing lithium ions. Examples of materials capable of occluding and releasing lithium ions include carbon materials such as graphite, non-graphitizable carbon, graphitizable carbon, fibrous carbon, coke, and carbon black. Examples of non-carbon materials include silicon, tin, and alloys and oxides mainly containing these materials. A mixture of carbon and non-carbon materials may also be used.

Positive-electrode protecting layers having an electric resistance greater than that of the positive electrode active material mixture layers may be provided on the positive electrode tab portion of each positive electrode plate in regions near the ends of the positive electrode active material mixture layers. Portions of the positive-electrode protecting layers may be formed on the positive electrode active material mixture layers.

The positive-electrode protecting layers preferably contain ceramic particles and a binder. Preferably, the positive-electrode protecting layers also contain a conductive member, such as a carbon material. The positive-electrode protecting layers may instead be insulating layers.

The amount of lithium carbonate contained in the positive electrode active material mixture layers is preferably 0.1 to 5 mass % of the amount of positive electrode active material, and more preferably 0.5 to 3 mass % of the amount of positive electrode active material.

The positive electrode active material mixture layers preferably further contain lithium phosphate. In such a case, abnormal reaction in the secondary battery can be suppressed when the secondary battery is overcharged, and the reliability of the secondary battery can be increased.

The positive electrode plates and the negative electrode plates may be bonded to the separators by using, for example, polyvinylidene fluoride (PVDF), carboxymethyl cellulose (CMC), or polyvinyl alcohol (PVA).

### REFERENCE SIGNS LIST

20 . . . rectangular secondary battery, 100 . . . battery case, 1 . . . exterior body,
2 . . . sealing plate, 3 . . . electrode assembly, 4 . . . positive electrode plate,
4a . . . positive electrode core, 4b . . . positive electrode active material mixture layer, 4b1 . . . flat region,
4b2 . . . inclined portion, 4b3 . . . first region, 4b4 . . . second region,
4c . . . positive electrode exposed core portion, 4A . . . main portion, 40 . . . positive electrode tab portion,
4X . . . boundary,
5 . . . negative electrode plate, 5a . . . negative electrode core, 5b . . . negative electrode active material mixture layer,
5c . . . negative electrode exposed core portion, 50 . . . negative electrode tab portion,
6 . . . positive electrode current collector, 6x . . . fixing opening, 6y . . . thin portion,
7 . . . positive electrode external terminal,
7a . . . terminal sealing member, 7x . . . metal plate,
7y . . . rubber member,
8 . . . negative electrode current collector, 9 . . . negative electrode external terminal, 10 . . . inner insulating member,
11 . . . outer insulating member, 12 . . . inner insulating member, 13 . . . outer insulating member,
14 . . . insulating sheet, 15 . . . electrolytic solution introduction hole, 16 . . . sealing plug,
17 . . . gas discharge valve, 60 . . . current interruption mechanism,
61 . . . conductive member, 62 . . . deformation plate, 63 . . . insulating member,
63a . . . projecting portion, 63x . . . insulating member opening,
70 . . . compression roller,
80 . . . short circuiting mechanism,
81 . . . deformation plate, 82 . . . external conductive member,
104, 204, 304 . . . positive electrode plate,
104a, 204a, 304a . . . positive electrode core,
104b, 204b, 304b . . . positive electrode active material mixture layer,
304b1 . . . flat region, 304b2 . . . inclined portion,
104A, 204A, 304A . . . main portion,
140, 240, 340 . . . positive electrode tab portion,
106 . . . positive electrode current collector, 90 . . . opening

1. A method for manufacturing a secondary battery including an electrode assembly including a first electrode plate and a second electrode plate, the first electrode plate including a core and an active material mixture layer formed on the core, the first electrode plate having a main portion and a tab portion formed of a portion of the core that projects from an end of the main portion, the method comprising:
an active-material-mixture-layer-forming step of forming the active material mixture layer on the core such that the core includes an exposed core portion on which the active material mixture layer is not formed;
a tab-portion-forming step of forming the tab portion by cutting the exposed core portion after the active-material-mixture-layer-forming step; and
a compression step of compressing the active material mixture layer after the tab-portion-forming step,
wherein, in the active-material-mixture-layer-forming step, the active material mixture layer is formed on the core such that the active material mixture layer includes an inclined portion in which a thickness of the active material mixture layer gradually decreases toward the exposed core portion in a region near an end of the active material mixture layer that is adjacent to the exposed core portion, and
wherein, in the tab-portion-forming step, the core is cut such that a boundary between the main portion and the tab portion is at the inclined portion.

2. The method for manufacturing the secondary battery according to claim 1, wherein, in the active-material-mixture-layer-forming step, the active material mixture layer is formed to extend in a longitudinal direction of the core having an elongated shape on each side of the core such that the exposed core portion is formed on each side of the core at an end in a width direction of the core.

3. The method for manufacturing the secondary battery according to claim 2, wherein, in the tab-portion-forming step, a plurality of the tab portions are formed with gaps therebetween in the longitudinal direction of the core, and
wherein the core and the active material mixture layer are cut in the longitudinal direction of the core at the inclined portion in regions between the tab portions that are adjacent to each other.

4. The method for manufacturing the secondary battery according to claim 1, wherein, in the tab-portion-forming step, a plurality of the tab portions are formed with gaps therebetween in a longitudinal direction of the core, and
wherein a distance in the longitudinal direction of the core between the tab portions that are adjacent to each other in the longitudinal direction of the core is greater than or equal to three times a width of the tab portions in the longitudinal direction of the core.

5. The method for manufacturing the secondary battery according to claim 1, wherein, in the tab-portion-forming step, the core is cut by irradiation with an energy ray.

6. The method for manufacturing the secondary battery according to claim 1,
wherein the secondary battery further includes
a battery case that contains the electrode assembly,
a first electrode external terminal that is attached to the battery case and electrically connected to the first electrode plate, and
a current interruption mechanism or a short circuiting mechanism, the current interruption mechanism being activated when a pressure in the battery case reaches or exceeds a predetermined value and breaking a conductive path between the first electrode plate and the first electrode external terminal, the short circuiting mechanism being activated when the pressure in the battery case reaches or exceeds a predetermined value and electrically short-circuiting the first electrode plate and the second electrode plate,
wherein the first electrode plate is a positive electrode plate, and
wherein the active material mixture layer contains lithium carbonate.

7. The method for manufacturing the secondary battery according to claim 1, wherein the electrode assembly includes a separator disposed between the first electrode plate and the second electrode plate, and wherein the method further comprises a step of bonding the first electrode plate and the separator together.

8. A secondary battery comprising:
an electrode assembly including a first electrode plate and a second electrode plate, the first electrode plate including a core and an active material mixture layer formed on the core, the first electrode plate having a main portion and a tab portion formed of a portion of the core that projects from an end of the main portion,
wherein a packing density of a portion of the active material mixture layer located at a boundary between the main portion and the tab portion is less than a packing density of the active material mixture layer in a central region of the main portion.

9. The secondary battery according to claim 8, wherein a region in which the active material mixture layer has a packing density less than the packing density of the active material mixture layer in the central region of the main portion is formed along an edge of the main portion on which the tab portion is provided at the end of the main portion.

10. The secondary battery according to claim 8, further comprising:
a battery case that contains the electrode assembly;
a first electrode external terminal that is attached to the battery case and electrically connected to the first electrode plate; and
a current interruption mechanism or a short circuiting mechanism, the current interruption mechanism being activated when a pressure in the battery case reaches or exceeds a predetermined value and breaking a conductive path between the first electrode plate and the first electrode external terminal, the short circuiting mechanism being activated when the pressure in the battery case reaches or exceeds a predetermined value and short-circuiting the first electrode plate and the second electrode plate,
wherein the first electrode plate is a positive electrode plate, and
wherein the active material mixture layer contains lithium carbonate.

11. The secondary battery according to claim 8, wherein the electrode assembly includes a separator disposed between the first electrode plate and the second electrode plate, and wherein the first electrode plate and the separator are bonded together.

12. The secondary battery according to claim 8, wherein the active material mixture layer is melted and solidified along an edge of the main portion on which the tab portion is provided.

13. The secondary battery according to claim 8, wherein a length of an edge of the main portion on which the tab portion is provided is greater than or equal to three times a width of the tab portion in a direction in which the edge extends.
